(19) United States
(12) Patent Application Publication
(10) Pub. No.: US 2026/0074412 A1
(43) Pub. Date: Mar. 12, 2026

(54) Electronic Device Antenna with Housing-Integrated Parasitic

(71) Applicant: Apple Inc., Cupertino, CA (US)

(72) Inventors: Linyu Cai, Shenzhen (CN); Alden T Rush, San Diego, CA (US); Sai Kiran Doddalla, San Diego, CA (US); Han Wang, Campbell, CA (US); Lu Zhang, Shanghai (CN); Hao Xu, Cupertino, CA (US); Carlo Di Nallo, Belmont, CA (US); Mattia Pascolini, San Francisco, CA (US)

(21) Appl. No.: 18/826,617

(22) Filed: Sep. 6, 2024

(51) Int. Cl. H01Q 1/24; H01Q 1/42; H01Q 1/48; H01Q 9/04; H01Q 19/00

(52) U.S. Cl. CPC H01Q 1/243; H01Q 1/422; H01Q 1/48; H01Q 9/0414; H01Q 19/005

(57) ABSTRACT

An electronic device may be provided with an antenna that radiates through a rear housing wall. The antenna may include a first patch and a second patch in a first plane and may include a third patch in a second plane. The antenna may include a conductive interconnect that couples the third patch to a ground trace. The first patch may be separated from the second patch by a first gap. The first patch may be separated from the third patch by a second gap. The first patch may be directly fed, may indirectly feed the second patch across the first gap, and may indirectly feed the third patch across the second gap. The third patch may be formed from a conductive support plate of the rear housing wall.

### FIELD

This relates generally to electronic devices, including electronic devices with wireless communications capabilities.

### BACKGROUND

Electronic devices such as portable computers and cellular telephones are often provided with wireless communications capabilities. To satisfy consumer demand for small form factor wireless devices, manufacturers are continually striving to implement wireless communications circuitry such as antenna components using compact structures. At the same time, there is a desire for wireless devices to cover a growing number of communications bands.

Because antennas have the potential to interfere with each other and with components in a wireless device, care must be taken when incorporating antennas into an electronic device. Moreover, care must be taken to ensure that the antennas and wireless circuitry in a device are able to exhibit satisfactory performance over a range of operating frequencies while still allowing the device to exhibit a compact form factor.

### SUMMARY

An electronic device may be provided with an antenna module having an antenna that radiates through a rear housing wall. The antenna module may include ground traces on a flexible printed circuit and a substrate mounted to the flexible printed circuit.

The antenna may include a first patch and a second patch in a first plane and may include a third patch in a second plane. The antenna may include a conductive interconnect that couples the third patch to the ground traces. The first patch may be separated from the second patch by a first gap. The first patch may be separated from the third patch by a second gap. The first patch may be directly fed. The first patch may indirectly feed the second patch across the first gap. The second patch may form a first parasitic element for the antenna. The first patch may indirectly feed the third patch across the second gap. The third patch and the conductive interconnect may form a second parasitic element for the antenna. The third patch may be formed from a conductive support plate of the rear housing wall.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a schematic diagram of illustrative wireless circuitry in accordance with some embodiments.

FIG. 4 is a diagram of an illustrative electronic device in wireless communication with an external node in a network in accordance with some embodiments.

FIG. 5 is a diagram showing how the location (e.g., range and angle of arrival) of an external node in a network may be determined relative to an electronic device in accordance with some embodiments.

FIG. 6 is a cross-sectional side view of an electronic device having housing structures that may be used in forming antenna structures in accordance with some embodiments.

FIG. 7 is a perspective view of an illustrative antenna that includes coplanar parasitic and directly fed patches in accordance with some embodiments.

FIG. 8 is a perspective view of an illustrative antenna that includes a first parasitic patch coplanar with a directly fed patch and that includes a second parasitic patch overlapping the directly fed patch in accordance with some embodiments.

FIG. 9 is a cross-sectional side view showing how the second parasitic patch of FIG. 8 may be formed from a portion of an electronic device housing support plate in accordance with some embodiments.

FIG. 10 is a plot of antenna performance (antenna efficiency) as a function of frequency for antennas of the types shown in FIGS. 7-9 in accordance with some embodiments.

### DETAILED DESCRIPTION

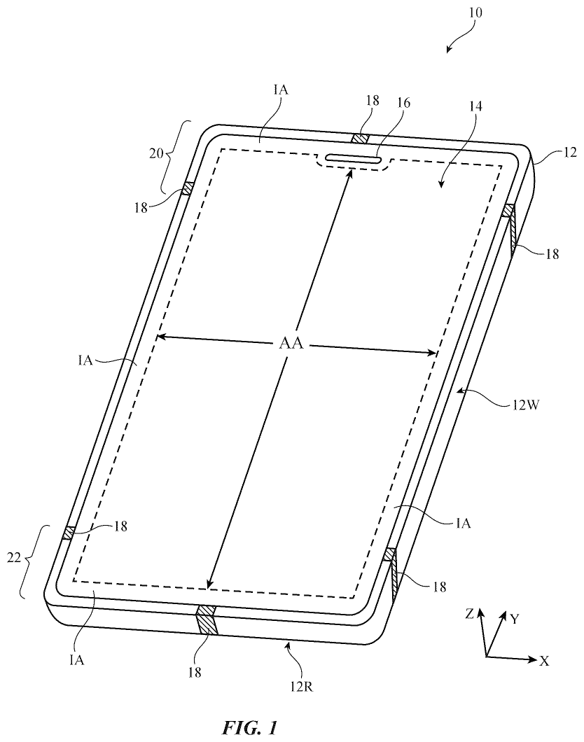

An electronic device such as electronic device 10 of FIG. 1 may be provided with wireless circuitry that includes antennas. The antennas may be used to transmit and/or receive wireless radio-frequency signals in different frequency bands and/or using different radio access technologies.

Device 10 may be a portable electronic device or other suitable electronic device. For example, device 10 may be a laptop computer, a tablet computer, a somewhat smaller device such as a wrist-watch device, pendant device, headphone device, earpiece device, headset device (e.g., virtual, augmented, or mixed reality glasses or goggles), or another wearable or miniature device, a handheld device such as a cellular telephone, a media player, or other small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed of a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (e.g., peripheral conductive housing structures 12W may cover only the edge of housing 12 that surrounds display 14 and not the rest of the sidewalls of housing 12).

Rear housing wall 12R may lie in a plane that is parallel to display 14. Rear housing wall 12R of device 10 may include one or more dielectric layers (e.g., dielectric cover layers) such as a glass, ceramic, sapphire and/or plastic layer. If desired, some or all of rear housing wall 12R may be formed from metal (e.g., metal overlapping the one or more dielectric layers). Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color. Inactive area IA may include a recessed region such as a notch that extends into active area AA. Active area AA may, for example, be defined by the lateral area of a display module for display 14 (e.g., a display module that includes pixel circuitry, touch sensor circuitry, etc.). The display module may have a recess or notch in upper region 20 of device 10 that is free from active display circuitry (i.e., that forms the notch of inactive area IA). The notch may be a substantially rectangular region that is surrounded (defined) on three sides by active area AA and on a fourth side by peripheral conductive housing structures 12W. Alternatively, the notch may be defined on all sides by (e.g., may be surrounded and enclosed by) active area AA (e.g., the notch may form an inactive island in the pixel circuitry of display 14). One or more sensors may be aligned with the notch and may transmit and/or receive light through display 14 within the notch.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 in the notch or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is merely illustrative.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. An example in which device 10 includes three or four upper antennas and five lower antennas is described herein as an example. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is merely illustrative. If desired, housing 12 may have other shapes (e.g., a square shape, cylindrical shape, spherical shape, combinations of these and/or different shapes, etc.).

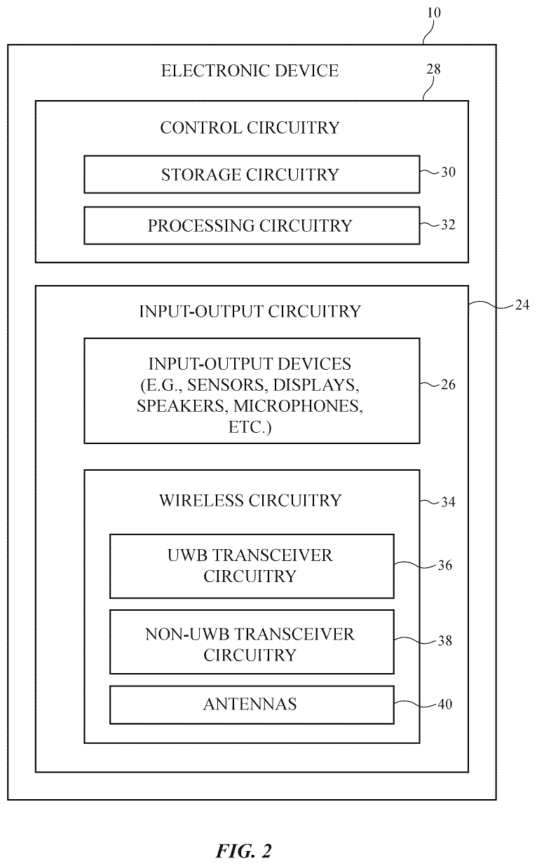

A schematic diagram of illustrative components that may be used in device 10 is shown in FIG. 2. As shown in FIG. 2, device 10 may include control circuitry 28. Control circuitry 28 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 28 may include processing circuitry such as processing circuitry 32. Processing circuitry 32 may be used to control the operation of device 10. Processing circuitry 32 may include on one or more processors such as microprocessors, microcontrollers, digital signal processors, host processors, baseband processor integrated circuits, application specific integrated circuits, central processing units (CPUs), graphics processing units, etc. Control circuitry 28 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 28 may be used to run software on device 10 such as internet browsing applications, voice-over-internet-protocol (VOIP) telephone call applications, email applications, media playback applications, operating system functions, etc. To support interactions with external equipment, control circuitry 28 may be used in implementing communications protocols. Communications protocols that may be implemented using control circuitry 28 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, etc.), antenna diversity protocols, satellite navigation system protocols (e.g., global positioning system (GPS) protocols, global navigation satellite system (GLONASS) protocols, etc.), antenna-based spatial ranging protocols, or any other desired communications protocols. Each communication protocol may be associated with a corresponding radio access technology (RAT) that specifies the physical connection methodology used in implementing the protocol.

Device 10 may include input-output circuitry 24. Input-output circuitry 24 may include input-output devices 26. Input-output devices 26 may be used to allow data to be supplied to device 10 and to allow data to be provided from device 10 to external devices. Input-output devices 26 may include user interface devices, data port devices, sensors, and other input-output components. For example, input-output devices may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components.

Input-output circuitry 24 may include wireless circuitry such as wireless circuitry 34 for wirelessly conveying radio-frequency signals. While control circuitry 28 is shown separately from wireless circuitry 34 in the example of FIG. 2 for the sake of clarity, wireless circuitry 34 may include processing circuitry that forms a part of processing circuitry 32 and/or storage circuitry that forms a part of storage circuitry 30 of control circuitry 28 (e.g., portions of control circuitry 28 may be implemented on wireless circuitry 34). As an example, control circuitry 28 may include baseband processor circuitry (e.g., one or more baseband processors) or other control components that form a part of wireless circuitry 34.

Wireless circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals (e.g., one or more RF front end modules, etc.). Wireless signals can also be sent using light (e.g., using infrared communications).

Wireless circuitry 34 may include radio-frequency transceiver circuitry for handling transmission and/or reception of radio-frequency signals within corresponding frequency bands at radio frequencies (sometimes referred to herein as communications bands or simply as “bands”). For example, wireless circuitry 34 may include ultra-wideband (UWB) transceiver circuitry 36 that supports communications using the IEEE 802.15.4 protocol and/or other ultra-wideband communications protocols. Ultra-wideband radio-frequency signals may be based on an impulse radio signaling scheme that uses band-limited data pulses. Ultra-wideband signals may have any desired bandwidths such as bandwidths between 499 MHz and 1331 MHz, bandwidths greater than 500 MHz, etc. The presence of lower frequencies in the baseband may sometimes allow ultra-wideband signals to penetrate through objects such as walls. In an IEEE 802.15.4 system, a pair of electronic devices may exchange wireless time stamped messages. Time stamps in the messages may be analyzed to determine the time of flight of the messages and thereby determine the distance (range) between the devices and/or an angle between the devices (e.g., an angle of arrival of incoming radio-frequency signals). Ultra-wideband transceiver circuitry 36 may operate (i.e., convey radio-frequency signals) in frequency bands such as an ultra-wideband communications band between about 5 GHz and about 8.5 GHz (e.g., a 6.5 GHz UWB communications band, an 8 GHz UWB communications band, and/or at other suitable frequencies).

As shown in FIG. 2, wireless circuitry 34 may also include non-UWB transceiver circuitry 38. Non-UWB transceiver circuitry 38 may handle communications bands other than UWB communications bands such as wireless local area network (WLAN) frequency bands (e.g., Wi-Fi® (IEEE 802.11) or other WLAN communications bands) including a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands including the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands, sub-THz or THz bands between around 100 GHz and 10 THz, etc.), other centimeter or millimeter wave frequency bands between 10-300 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), communications bands under the family of 3GPP wireless communications standards, communications bands under the IEEE 802.XX family of standards, industrial, scientific, and medical (ISM) bands such as an ISM band between around 900 MHz and 950 MHz or other ISM bands below or above 1 GHz, one or more unlicensed bands, one or more bands reserved for emergency and/or public services, and/or any other desired frequency bands of interest. Non-UWB transceiver circuitry 38 may also be used to perform spatial ranging operations if desired.

UWB transceiver circuitry 36 and non-UWB transceiver circuitry 38 may include respective transceivers (e.g., transceiver integrated circuits or chips) that handle each of these frequency bands or any desired number of transceivers that handle two or more of these frequency bands. In scenarios where different transceivers are coupled to the same antenna, filter circuitry (e.g., duplexer circuitry, diplexer circuitry, low pass filter circuitry, high pass filter circuitry, band pass filter circuitry, band stop filter circuitry, etc.), switching circuitry, multiplexing circuitry, or any other desired circuitry may be used to isolate radio-frequency signals conveyed by each transceiver over the same antenna (e.g., filtering circuitry or multiplexing circuitry may be interposed on a radio-frequency transmission line shared by the transceivers). The transceiver circuitry may include one or more integrated circuits (chips), integrated circuit packages (e.g., multiple integrated circuits mounted on a common printed circuit in a system-in-package device, one or more integrated circuits mounted on different substrates, etc.), power amplifier circuitry, up-conversion circuitry, down-conversion circuitry, low-noise input amplifiers, passive radio-frequency components, switching circuitry, transmission line structures, and other circuitry for handling radio-frequency signals and/or for converting signals between radio-frequencies, intermediate frequencies, and/or baseband frequencies.

As shown in FIG. 2, wireless circuitry 34 may include antennas 40. UWB transceiver circuitry 36 and non-UWB transceiver circuitry 38 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to freespace through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna types. For example, antennas 40 may include antennas with resonating elements that are formed from stacked patch antenna structures, loop antenna structures, patch antenna structures, inverted-F antenna structures, slot antenna structures, planar inverted-F antenna structures, waveguide structures, monopole antenna structures, dipole antenna structures, helical antenna structures, Yagi (Yagi-Uda) antenna structures, hybrids of these designs, etc. In another suitable arrangement, antennas 40 may include antennas with dielectric resonating elements such as dielectric resonator antennas. If desired, one or more of antennas 40 may be cavity-backed antennas. Two or more antennas 40 may be arranged in a phased antenna array if desired (e.g., for conveying centimeter and/or millimeter wave signals). Different types of antennas may be used for different bands and combinations of bands.

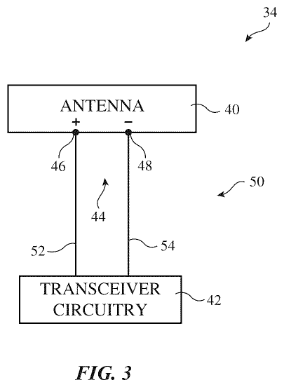

A schematic diagram of wireless circuitry 34 is shown in FIG. 3. As shown in FIG. 3, wireless circuitry 34 may include transceiver circuitry 42 (e.g., UWB transceiver circuitry 36 or non-UWB transceiver circuitry 38 of FIG. 2) that is coupled to a given antenna 40 using a radio-frequency transmission line path such as radio-frequency transmission line path 50.

To provide antenna structures such as antenna 40 with the ability to cover different frequencies of interest, antenna 40 may be provided with circuitry such as filter circuitry (e.g., one or more passive filters and/or one or more tunable filter circuits). Discrete components such as capacitors, inductors, and resistors may be incorporated into the filter circuitry. Capacitive structures, inductive structures, and resistive structures may also be formed from patterned metal structures (e.g., part of an antenna). If desired, antenna 40 may be provided with adjustable circuits such as tunable components that tune the antenna over communications (frequency) bands of interest. The tunable components may be part of a tunable filter or tunable impedance matching network, may be part of an antenna resonating element, may span a gap between an antenna resonating element and antenna ground, etc.

Radio-frequency transmission line path 50 may include one or more radio-frequency transmission lines (sometimes referred to herein simply as transmission lines). Radio-frequency transmission line path 50 (e.g., the transmission lines in radio-frequency transmission line path 50) may include a positive signal conductor such as positive signal conductor 52 and a ground signal conductor such as ground conductor 54.

The transmission lines in radio-frequency transmission line path 50 may, for example, include coaxial cable transmission lines (e.g., ground conductor 54 may be implemented as a grounded conductive braid surrounding signal conductor 52 along its length), stripline transmission lines (e.g., where ground conductor 54 extends along two sides of signal conductor 52), a microstrip transmission line (e.g., where ground conductor 54 extends along one side of signal conductor 52), coaxial probes realized by a metalized via, edge-coupled microstrip transmission lines, edge-coupled stripline transmission lines, waveguide structures (e.g., coplanar waveguides or grounded coplanar waveguides), combinations of these types of transmission lines and/or other transmission line structures, etc.

Transmission lines in radio-frequency transmission line path 50 may be integrated into rigid and/or flexible printed circuit boards. In one suitable arrangement, radio-frequency transmission line path 50 may include transmission line conductors (e.g., signal conductors 52 and ground conductors 54) integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

A matching network may include components such as inductors, resistors, and capacitors used in matching the impedance of antenna 40 to the impedance of radio-frequency transmission line path 50. Matching network components may be provided as discrete components (e.g., surface mount technology components) or may be formed from housing structures, printed circuit board structures, traces on plastic supports, etc. Components such as these may also be used in forming filter circuitry in antenna(s) 40 and may be tunable and/or fixed components.

Radio-frequency transmission line path 50 may be coupled to antenna feed structures associated with antenna 40. As an example, antenna 40 may form an inverted-F antenna, a planar inverted-F antenna, a patch antenna, or other antenna having an antenna feed 44 with a positive antenna feed terminal such as positive antenna feed terminal 46 and a ground antenna feed terminal such as ground antenna feed terminal 48. Positive antenna feed terminal 46 may be coupled to an antenna resonating element for antenna 40 (e.g., a fed arm of antenna 40). Ground antenna feed terminal 48 may be coupled to an antenna ground for antenna 40. If desired, antenna 40 may have one or more antenna resonating elements that are not coupled or directly connected to a corresponding positive antenna feed terminal (e.g., a parasitic or unfed arm of antenna 40). The unfed arm(s) in antenna 40 may, if desired, be fed by one or more fed arms of antenna 40 (e.g., via near-field electromagnetic coupling).

Signal conductor 52 may be coupled to positive antenna feed terminal 46 and ground conductor 54 may be coupled to ground antenna feed terminal 48. Other types of antenna feed arrangements may be used if desired. For example, antenna 40 may be fed using multiple feeds each coupled to a respective port of transceiver circuitry 42 over a corresponding transmission line. If desired, signal conductor 52 may be coupled to multiple locations on antenna 40 (e.g., antenna 40 may include multiple positive antenna feed terminals coupled to signal conductor 52 of the same radio-frequency transmission line path 50). Switches may be interposed on the signal conductor between transceiver circuitry 42 and the positive antenna feed terminals if desired (e.g., to selectively activate one or more positive antenna feed terminals at any given time). The illustrative feeding configuration of FIG. 3 is merely illustrative.

During operation, device 10 may communicate with external wireless equipment. If desired, device 10 may use radio-frequency signals conveyed between device 10 and the external wireless equipment to identify a location of the external wireless equipment relative to device 10. Device 10 may identify the relative location of the external wireless equipment by identifying a range to the external wireless equipment (e.g., the distance between the external wireless equipment and device 10) and the angle of arrival (AoA) of radio-frequency signals from the external wireless equipment (e.g., the angle at which radio-frequency signals are received by device 10 from the external wireless equipment).

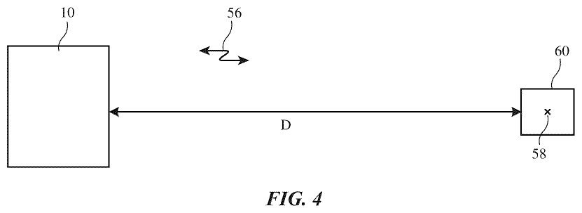

FIG. 4 is a diagram showing how device 10 may determine a distance D between device 10 and external wireless equipment such as wireless network node 60 (sometimes referred to herein as wireless equipment 60, wireless device 60, external device 60, or external equipment 60). Node 60 may include devices that are capable of receiving and/or transmitting radio-frequency signals such as radio-frequency signals 56. Node 60 may include tagged devices (e.g., any suitable object that has been provided with a wireless receiver and/or a wireless transmitter), electronic equipment (e.g., an infrastructure-related device), and/or other electronic devices (e.g., devices of the type described in connection with FIG. 1, including some or all of the same wireless communications capabilities as device 10).

For example, node 60 may be a laptop computer, a tablet computer, a somewhat smaller device such as a wrist-watch device, pendant device, headphone device, earpiece device, headset device (e.g., virtual or augmented reality headset devices), or other wearable or miniature device, a handheld device such as a cellular telephone, a media player, or other small portable device. Node 60 may also be a set-top box, a camera device with wireless communications capabilities, a desktop computer, a display into which a computer or other processing circuitry has been integrated, a display without an integrated computer, or other suitable electronic equipment. Node 60 may also be a key fob, a wallet, a book, a pen, or other object that has been provided with a low-power transmitter (e.g., an RFID transmitter or other transmitter). Node 60 may be electronic equipment such as a thermostat, a smoke detector, a Bluetooth® Low Energy (Bluetooth LE) beacon, a Wi-Fi® wireless access point, a wireless base station, a server, a heating, ventilation, and air conditioning (HVAC) system (sometimes referred to as a temperature-control system), a light source such as a light-emitting diode (LED) bulb, a light switch, a power outlet, an occupancy detector (e.g., an active or passive infrared light detector, a microwave detector, etc.), a door sensor, a moisture sensor, an electronic door lock, a security camera, or other device. Device 10 may also be one of these types of devices if desired.

As shown in FIG. 4, device 10 may communicate with node 60 using wireless radio-frequency signals 56. Radio-frequency signals 56 may include Bluetooth® signals, near-field communications signals, wireless local area network signals such as IEEE 802.11 signals, millimeter wave communication signals such as signals at 60 GHz, UWB signals, other radio-frequency wireless signals, infrared signals, etc. In one suitable arrangement that is described herein by example, radio-frequency signals 56 are UWB signals conveyed in one or more UWB communications bands such as the 6.5 GHz and 8 GHz UWB communications bands. Radio-frequency signals 56 may be used to determine and/or convey information such as location and orientation information. For example, control circuitry 28 in device 10 (FIG. 2) may determine the location 58 of node 60 relative to device 10 using radio-frequency signals 56.

In arrangements where node 60 is capable of sending or receiving communications signals, control circuitry 28 (FIG. 2) on device 10 may determine distance D using radio-frequency signals 56 of FIG. 4. The control circuitry may determine distance D using signal strength measurement schemes (e.g., measuring the signal strength of radio-frequency signals 56 from node 60) or using time-based measurement schemes such as time of flight measurement techniques, time difference of arrival measurement techniques, angle of arrival measurement techniques, triangulation methods, time-of-flight methods, using a crowdsourced location database, and other suitable measurement techniques. This is merely illustrative, however. If desired, the control circuitry may use information from Global Positioning System receiver circuitry, proximity sensors (e.g., infrared proximity sensors or other proximity sensors), image data from a camera, motion sensor data from motion sensors, and/or using other circuitry on device 10 to help determine distance D. In addition to determining the distance D between device 10 and node 60, the control circuitry may determine the orientation of device 10 relative to node 60.

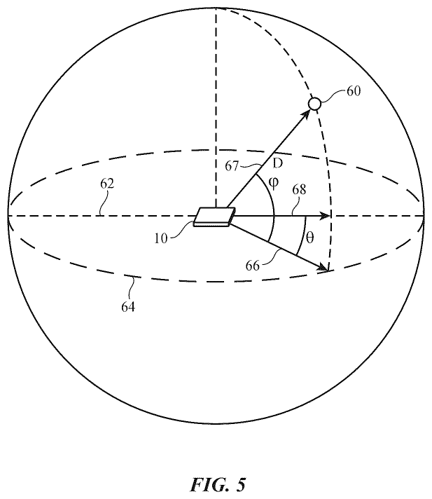

FIG. 5 illustrates how the position and orientation of device 10 relative to nearby nodes such as node 60 may be determined. In the example of FIG. 5, the control circuitry on device 10 (e.g., control circuitry 28 of FIG. 2) uses a horizontal polar coordinate system to determine the location and orientation of device 10 relative to node 60. In this type of coordinate system, the control circuitry may determine an azimuth angle θ and/or an elevation angle φ to describe the position of nearby nodes 60 relative to device 10. The control circuitry may define a reference plane such as local horizon 64 and a reference vector such as reference vector 68. Local horizon 64 may be a plane that intersects device 10 and that is defined relative to a surface of device 10 (e.g., the front or rear face of device 10). For example, local horizon 64 may be a plane that is parallel to or coplanar with display 14 of device 10 (FIG. 1). Reference vector 68 (sometimes referred to as the “north” direction) may be a vector in local horizon 64. If desired, reference vector 68 may be aligned with longitudinal axis 62 of device 10 (e.g., an axis running lengthwise down the center of device 10 and parallel to the longest rectangular dimension of device 10, parallel to the Y-axis of FIG. 1). When reference vector 68 is aligned with longitudinal axis 62 of device 10, reference vector 68 may correspond to the direction in which device 10 is being pointed.

Azimuth angle θ and elevation angle φ may be measured relative to local horizon 64 and reference vector 68. As shown in FIG. 5, the elevation angle φ (sometimes referred to as altitude) of node 60 is the angle between node 60 and local horizon 64 of device 10 (e.g., the angle between vector 67 extending between device 10 and node 60 and a coplanar vector 66 extending between device 10 and local horizon 64). The azimuth angle θ of node 60 is the angle of node 60 around local horizon 64 (e.g., the angle between reference vector 68 and vector 66). In the example of FIG. 5, the azimuth angle θ and elevation angle φ of node 60 are greater than 0°.

If desired, other axes besides longitudinal axis 62 may be used to define reference vector 68. For example, the control circuitry may use a horizontal axis that is perpendicular to longitudinal axis 62 as reference vector 68. This may be useful in determining when nodes 60 are located next to a side portion of device 10 (e.g., when device 10 is oriented side-to-side with one of nodes 60).

After determining the orientation of device 10 relative to node 60, the control circuitry on device 10 may take suitable action. For example, the control circuitry may send information to node 60, may request and/or receive information from 60, may use display 14 (FIG. 1) to display a visual indication of wireless pairing with node 60, may use speakers to generate an audio indication of wireless pairing with node 60, may use a vibrator, a haptic actuator, or other mechanical element to generate haptic output indicating wireless pairing with node 60, may use display 14 to display a visual indication of the location of node 60 relative to device 10, may use speakers to generate an audio indication of the location of node 60, may use a vibrator, a haptic actuator, or other mechanical element to generate haptic output indicating the location of node 60, and/or may take other suitable action.

In one suitable arrangement, device 10 may determine the distance between the device 10 and node 60 and the orientation of device 10 relative to node 60 using one or more ultra-wideband antennas. The ultra-wide band antennas may receive radio-frequency signals from node 60 (e.g., radio-frequency signals 56 of FIG. 4). Time stamps in the wireless communication signals may be analyzed to determine the time of flight of the wireless communication signals and thereby determine the distance (range) between device 10 and node 60. In implementations where device 10 includes two or more ultra-wideband antennas, angle of arrival (AoA) measurement techniques may be used to determine the orientation of electronic device 10 relative to node 60 (e.g., azimuth angle θ and elevation angle φ).

In angle of arrival measurement, node 60 transmits a radio-frequency signal to device 10 (e.g., radio-frequency signals 56 of FIG. 4). Device 10 may measure a delay in arrival time of the radio-frequency signals between the two or more ultra-wideband antennas. The delay in arrival time (e.g., the difference in received phase at each ultra-wideband antenna) can be used to determine the angle of arrival of the radio-frequency signal (and therefore the angle of node 60 relative to device 10). Once distance D and the angle of arrival have been determined, device 10 may have knowledge of the precise location of node 60 relative to device 10.

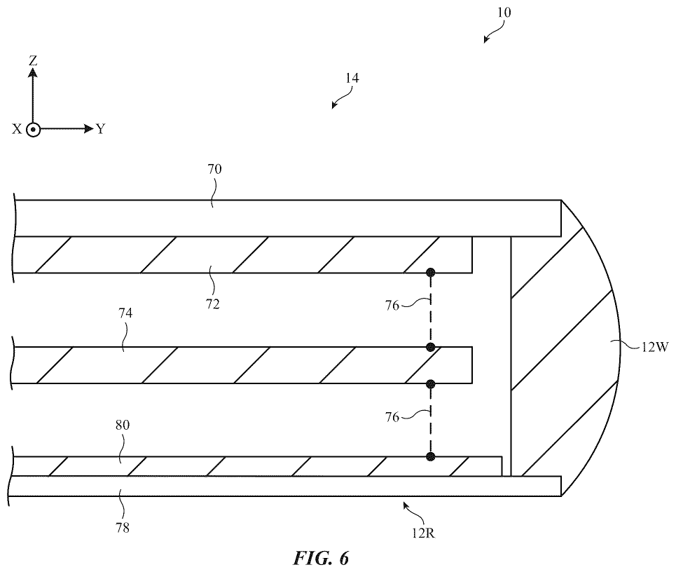

If desired, conductive electronic device structures such as conductive portions of housing 12 (FIG. 1) may be used to form at least part of one or more of the antennas 40 in device 10. FIG. 6 is a cross-sectional side view of device 10, showing illustrative conductive electronic device structures that may be used in forming one or more of the antennas 40 in device 10.

As shown in FIG. 6, peripheral conductive housing structures 12W may extend around the lateral periphery of device 10 (e.g., as measured in the X-Y plane of FIG. 1). Peripheral conductive housing structures 12W may extend from rear housing wall 12R (e.g., at the rear face of device 10) to display 14 (e.g., at the front face of device 10). In other words, peripheral conductive housing structures 12W may form conductive sidewalls for device 10, a first of which is shown in the cross-sectional side view of FIG. 6 (e.g., a given sidewall that runs along an edge of device 10 and that extends across the width or length of device 10).

Display 14 may have a display module such as display module 72 (sometimes referred to as a display panel). Display module 72 may include pixel circuitry, touch sensor circuitry, force sensor circuitry, and/or any other desired circuitry for forming active area AA of display 14 (FIG. 1). Display 14 may include a dielectric cover layer such as display cover layer 70 that overlaps display module 70. Display cover layer 70 may include plastic, glass, sapphire, ceramic, and/or any other desired dielectric materials. Display module 72 may emit image light and may receive sensor input (e.g., touch and/or force sensor input) through display cover layer 70. Display cover layer 70 and display 14 may be mounted to peripheral conductive housing structures 12W. The lateral area of display 14 that does not overlap display module 72 may form inactive area IA of display 14 (FIG. 1).

As shown in FIG. 6, rear housing wall 12R may be mounted to peripheral conductive housing structures 12W (e.g., opposite display 14). Rear housing wall 12R may include a conductive layer such as conductive support plate 80. Conductive support plate 80 may extend across an entirety of the width of device 10 (e.g., between the left and right edges of device 10 as shown in FIG. 1). Conductive support plate 80 may be formed from an integral portion of peripheral conductive housing structures 12W that extends across the width of device 10 or may include a separate housing structure attached, coupled, or affixed to peripheral conductive housing structures 12W.

If desired, rear housing wall 12R may include a dielectric cover layer such as dielectric cover layer 78. Dielectric cover layer 78 may include glass, plastic, sapphire, ceramic, one or more dielectric coatings, or other dielectric materials. Dielectric cover layer 78 may be layered under conductive support plate 80 (e.g., conductive support plate 80 may be coupled or mounted to an interior surface of dielectric cover layer 78). If desired, dielectric cover layer 78 may extend across an entirety of the width of device 10 and/or an entirety of the length of device 10. Conductive support plate 80 may, if desired, be a removable support plate or a support plate integrated into a removable assembly or sub-assembly in device 10 that is removable from rear housing wall 12R (e.g., there may be no adhesive attaching conductive support plate 80 to dielectric cover layer 78). Conductive support plate 80 is sometimes also referred to herein as conductive housing wall 80, conductive plate 80, conductive back plate 80, back plate 80, or conductive rear chassis 80 for device 10.

The housing for device 10 may also include one or more additional conductive support plates interposed between display 14 and rear housing wall 12R. For example, the housing for device 10 may include a conductive support plate such as mid-chassis 74 (sometimes referred to herein as conductive support plate 74). Mid-chassis 74 may be vertically interposed between rear housing wall 12R and display 14 (e.g., conductive support plate 80 may be located at a first distance from display 14 whereas mid-chassis 74 is located at a second distance that is less than the first distance from display 14). Mid-chassis 74 may extend across an entirety of the width of device 10 (e.g., between the left and right edges of device 10 as shown in FIG. 1). Mid-chassis 74 may be formed from an integral portion of peripheral conductive housing structures 12W that extends across the width of device 10 or may include a separate housing structure attached, coupled, or affixed to peripheral conductive housing structures 12W. One or more components may be supported by mid-chassis 74 (e.g., logic boards such as a main logic board, a battery, etc.) and/or mid-chassis 74 may contribute to the mechanical strength of device 10. Mid-chassis 74 may be formed from metal (e.g., stainless steel, aluminum, etc.).

Conductive housing structures such as conductive support plate 80, mid-chassis 74, conductive portions of display module 72, and/or peripheral conductive housing structures 12W may be used to form antenna structures for one or more of the antennas 40 in device 10. For example, peripheral conductive housing structures 12W may form an antenna resonating element arm (e.g., an inverted-F antenna resonating element arm) for one or more of the antennas 40 in device 10. Mid-chassis 74, conductive support plate 80, and/or display module 72 may be used to form the corresponding antenna ground for one or more of the antennas 40 in device 10, a reflective antenna cavity backing, waveguide structures, etc. One or more conductive interconnect structures 76 may electrically couple mid-chassis 74 to conductive support plate 80 and/or one or more conductive interconnect structures 76 may electrically couple mid-chassis 74 to conductive structures in display module 72 (sometimes referred to herein as conductive display structures) so that each of these elements form part of the antenna ground. The conductive display structures may include a conductive frame, bracket, or support for display module 72, shielding layers in display module 72, ground traces in display module 72, etc.

Conductive interconnect structures 76 may serve to ground mid-chassis 74 to conductive support plate 80 and/or display module 72 (e.g., to ground conductive support plate 80 to the conductive display structures through mid-chassis 74). Put differently, conductive interconnect structures 76 may hold the conductive display structures, mid-chassis 74, and/or conductive support plate 80 to a common ground or reference potential (e.g., as a system ground for device 10 that is used to form part of the antenna ground). Conductive interconnect structures 76 may therefore sometimes be referred to herein as grounding structures 76, grounding interconnect structures 76, or vertical grounding structures 76. Conductive interconnect structures 76 may include conductive traces, conductive pins, conductive springs, conductive prongs, conductive brackets, conductive screws, conductive clips, conductive tape, conductive wires, conductive traces, conductive foam, conductive adhesive, solder, welds, metal members (e.g., sheet metal members), contact pads, conductive vias, conductive portions of one or more components mounted to mid-chassis 74 and/or conductive support plate 80, and/or any other desired conductive interconnect structures.

If desired, device 10 may include an antenna 40 that conveys radio-frequency signals through rear housing wall 12R (e.g., within the hemisphere over the rear face of device 10). If care is not taken, the compact form factor of device 10 can make it difficult for antennas to convey radio-frequency signals through rear housing wall 12R with sufficient levels of performance across one or more frequency bands of interest. To help broaden the bandwidth of antenna 40 without increasing the size of device 10, antenna 40 may include a directly fed antenna resonating element and one or more parasitic elements.

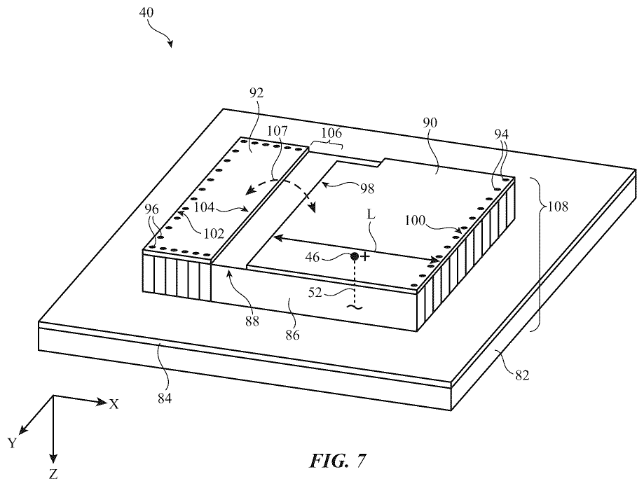

FIG. 7 is a perspective view showing one example of an antenna 40 that includes a directly fed antenna resonating element and a parasitic element for conveying radio-frequency signals through rear housing wall 12R. As shown in FIG. 7, antenna 40 may include a directly fed antenna resonating element such as directly fed patch 90 and may include an indirectly fed antenna resonating element such as parasitic patch 92.

The lateral area of parasitic patch 92 may extend parallel to the lateral area of directly fed patch 90. Parasitic patch 92 may, if desired, be coplanar with directly fed patch 90. For example, parasitic patch 92 and directly fed patch 90 may both be disposed on a lateral surface 88 of an underlying dielectric substrate such as substrate 86. Substrate 86 may be formed from plastic, ceramic, rigid or flexible printed circuit board material (e.g., polyimide, fiberglass, etc.), other dielectric materials, or a semiconductor such as a silicon bulk substrate. Substrate 86 is sometimes also referred to herein as antenna carrier 86 or antenna support 86.

If desired, substrate 86 may be mounted to an underlying substrate such as flexible printed circuit 82 (e.g., substrate 86 may be surface mounted to flexible printed circuit 82 using solder or other conductive adhesives). Flexible printed circuit 82 may include conductive traces that are held at a ground potential such as ground traces 84. Ground traces 84 may, for example, be formed in one or more grounded metallization layers of flexible printed circuit 82. Ground traces 84 may include ground traces disposed on the uppermost layer of flexible printed circuit 82 (e.g., substrate 86 may be surface mounted to ground traces 84) and/or may include ground traces embedded within flexible printed circuit 82. Flexible printed circuit 82 may be replaced with a rigid printed circuit board or another substrate if desired. Flexible printed circuit 82, substrate 86, and antenna 40 are sometimes also referred to collectively herein as antenna module 108.

Parasitic patch 92 and directly fed patch 90 may overlap ground traces 84. The lateral area of parasitic patch 92 and the lateral area of directly fed patch 90 may, if desired, extend parallel to ground traces 84 (e.g., parallel to the X-Y plane). Substrate 86 may separate directly fed patch 90 and parasitic patch 92 from ground traces 84 by a non-zero height.

Directly fed patch 90 may have a first lateral edge 98 facing parasitic patch 92 and may have an opposing second lateral edge 100 opposite lateral edge 98. Directly fed patch 90 may have a length L extending from lateral edge 98 to lateral edge 100. Length L may be selected to configure antenna 40 to resonate in a desired frequency band (e.g., length L may be approximately one-half or one-quarter the effective wavelength of operation of antenna 40, where effective wavelength is equal to a free space wavelength multiplied by a constant given by the dielectric properties of the materials around antenna 40).

Parasitic patch 92 may have a first lateral edge 104 facing directly fed patch 90 and may have an opposing second lateral edge 102 opposite lateral edge 104. Lateral edge 104 of parasitic patch 92 may be laterally separated from lateral edge 98 of directly fed patch 90 by gap 106 (e.g., a portion of lateral surface 88 that is free from conductive material). Parasitic patch 92 and directly fed patch 90 may be formed from conductors such as conductive traces, metal foil, sheet metal, or other conductive material on lateral surface 88. If desired, substrate 86 may be omitted (e.g., in implementations where parasitic patch 92 and directly fed patch 90 are held in place by other support structures, are formed from a rigid material such as folded sheet metal, etc.).

Directly fed patch 90 may be directly fed by the radio-frequency transmission line path for antenna 40. As such, the positive antenna feed terminal 46 for antenna 40 may be coupled to directly fed patch 90. The signal conductor 52 of the radio-frequency transmission line for antenna 40 may be coupled to positive antenna feed terminal 46. Signal conductor 52 may include a conductive via extending through substrate 86 or a feed probe or pin extending through an opening in substrate 86, as examples. If desired, signal conductor 52 may also include a conductive via extending through an opening in ground traces 84 (e.g., from a signal layer in flexible printed circuit 82) and/or a lateral signal trace extending through an opening in ground traces 84 on flexible printed circuit 82. This is illustrative and non-limiting and, in general directly fed patch 90 may be fed in any desired manner.

While conveying radio-frequency signals, antenna current flows through positive antenna feed terminal 46 and around the perimeter of directly fed patch 90. The antenna current may radiate radio-frequency signals at a frequency given by the dimensions of directly fed patch 90. Conversely, the antenna current may be produced by radio-frequency signals that are incident upon antenna 40. Directly fed patch 90 is sometimes also referred to herein as patch antenna resonating element 90, patch antenna element 90, patch element 90, patch radiator 90, patch resonator 90, conductive patch 90, directly fed patch element 90, directly fed patch antenna element 90, directly fed patch radiator 90, or directly fed patch resonator 90.

Parasitic patch 92 may serve to extend or broaden the bandwidth of antenna 40 (e.g., may broaden the frequencies covered by antenna 40 while conveying radio-frequency signals). For example, the antenna current running around the perimeter of directly fed patch 90 may induce corresponding antenna current that flows around the perimeter of parasitic patch 92 via near-field electromagnetic coupling 107 across gap 106. The antenna current on parasitic patch 92 may radiate radio-frequency signals at a frequency given by the dimensions of parasitic patch 92. Parasitic patch 92 may, for example, have a length (e.g., from lateral edge 102 to lateral edge 104) that is less than length L of directly fed patch 90. This causes parasitic patch 92 to contribute to the frequency response of antenna 40 at slightly different (e.g., higher) frequencies than directly fed patch 90, which serves to broaden the bandwidth of antenna 40. Conversely, the antenna current on parasitic patch 92 may be produced by radio-frequency signals incident upon antenna 40. The antenna current on parasitic patch 92 may induce corresponding antenna current on directly fed patch 90 via near-field electromagnetic coupling 107. Parasitic patch 92 and directly fed patch 90 may collectively form an antenna resonating element for antenna 40. Ground traces 84 may form part of an antenna ground for antenna 40.

If desired, parasitic patch 92 and/or directly fed patch 90 may be electrically floating (e.g., may be disconnected from ground traces 84). Alternatively, parasitic patch 92 and/or directly fed patch 90 may be coupled (e.g., electrically coupled, grounded, or shorted) to ground traces 84 by one or more conductive vias extending through substrate 86. For example, antenna 40 may include a fence of conductive vias 94 that couple directly fed patch 90 to ground traces 84 through substrate 86. Conductive vias 94 may, for example, extend along lateral edge 100 of directly fed patch 90. Additionally or alternatively, antenna 40 may include a fence of conductive vias 96 that couple parasitic patch 92 to ground traces 84 through substrate 86. Conductive vias 96 may, for example, extend along lateral edge 102 of parasitic patch 92 and/or one or both edges of parasitic patch 92 extending from lateral edge 102 to lateral edge 104.

Conductive vias 94 may, for example, configure directly fed patch 90 to form a planar inverted-F antenna resonating element arm. Conductive vias 94 may redistribute current flow on directly fed patch 90 and conductive vias 96 may redistribute current flow on parasitic patch 92 (e.g., causing some of the antenna current to short to ground traces 84 through the conductive vias). This may, for example, configure antenna 40 to cover lower frequencies than would otherwise be covered by an antenna having the same footprint but without the conductive vias. In implementations where parasitic patch 92 is coupled to ground traces 84 by conductive vias 96, parasitic patch 92 is sometimes also referred to herein as grounded parasitic patch 92, grounded parasitic 92, grounded parasitic antenna resonating element 92, or grounded parasitic antenna element 92. In implementations where directly fed patch 90 is coupled to ground traces 84 by conductive vias 94, directly fed patch 90 is sometimes also referred to herein as grounded patch 90, grounded directly fed patch 90, grounded patch element 90, or grounded patch 90.

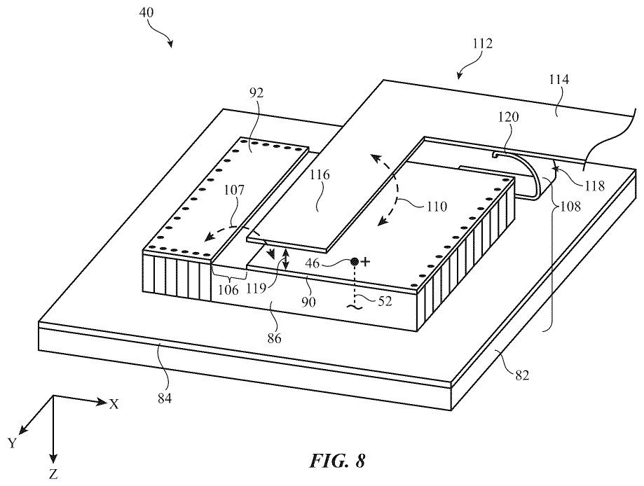

In general, the performance of antenna 40 may be directly proportional to the size of the radiating/resonating volume or aperture of antenna 40. To further increase the radiating/resonating volume or aperture of antenna 40, thereby increasing the wireless performance of antenna 40, antenna 40 may include an additional parasitic patch in a different plane than parasitic patch 92 and directly fed patch 90. FIG. 8 is a perspective view showing one example of how antenna 40 may include an additional parasitic patch in a different plane than parasitic patch 92 and directly fed patch 90.

As shown in FIG. 8, antenna 40 may include an additional parasitic patch 112. Parasitic patch 112 is non-coplanar with respect to parasitic patch 92 and directly fed patch 90. Parasitic patch 112 may, for example, overlap directly fed patch 90 and may be vertically separated from directly fed patch 90 by a gap 119 of non-zero height. If desired, parasitic patch 112 may also overlap gap 106 and/or parasitic patch 92 on substrate 86. Alternatively, parasitic patch 112 may be non-overlapping with respect to gap 106 and/or parasitic patch 92.

Parasitic patch 112 may be grounded to configure the parasitic patch to contribute to the radiative response of antenna 40. For example, as shown in FIG. 8, antenna 40 may include a conductive interconnect structure 118 that electrically couples parasitic patch 112 to ground traces 84 (e.g., bridging the vertical gap between parasitic patch 112 and ground traces 84). Conductive interconnect structure 118 may, for example, include a conductive spring finger 120 and/or any other desired conductive interconnect structures (e.g., conductive interconnect structures 76 of FIG. 6). Conductive interconnect structure 118 is sometimes also referred to herein simply as conductive interconnect 118. Parasitic patch 112 is sometimes also referred to herein as parasitic patch element 112, parasitic patch antenna element 112, parasitic patch antenna resonating element 112, parasitic radiator 112, parasitic element 112, parasitic 112, grounded parasitic patch 112, grounded parasitic 112, grounded parasitic patch antenna element 112, grounded parasitic patch antenna resonating element 112, grounded parasitic radiator 112, or grounded parasitic 112.

If desired, parasitic patch 112 may include a first portion that extends along a first longitudinal axis (e.g., parallel to the Y-axis) such as segment 116 and a second portion such as segment 114 that extends, from an end of segment 116 along a second longitudinal axis orthogonal to the first longitudinal axis (e.g., parallel to the X-axis). Segment 116 may overlap directly fed patch 90. If desired, segment 116 may also overlap some or all of gap 106 and/or parasitic patch 92. Segment 114 may partially overlap directly fed patch 90 or may be non-overlapping with respect to directly fed patch 90. When configured in this way, parasitic patch 112 form an L-shaped patch. This is illustrative and non-limiting. In general, parasitic patch 112 may include any desired number of segments extending at any desired angles with respect to each other and may have any desired number of straight and/or curved edges.

Parasitic patch 112 and conductive interconnect structure 118 may serve to further extend the bandwidth of antenna 40. For example, the antenna current running around the perimeter of directly fed patch 90 may induce corresponding antenna current that flows around the perimeter of parasitic patch 112 via near-field electromagnetic coupling 110 across gap 119 (e.g., concurrent with directly fed patch 90 inducing antenna current that flows around the perimeter of parasitic patch 92 via near-field electromagnetic coupling 107 across gap 106). The antenna current on parasitic patch 112 may also flow to ground traces 84 over conductive interconnect structure 118.

The antenna current flowing on parasitic patch 112 and flowing through conductive interconnect structure 118 may radiate radio-frequency signals at a frequency given by the dimensions of parasitic patch 112 (e.g., segment 116 and/or segment 114) and conductive interconnect structure 118. This causes parasitic patch 112 and conductive interconnect structure 118 to contribute to the frequency response of antenna 40 at slightly different frequencies than directly fed patch 90 and parasitic patch 92, which serves to further broaden the bandwidth of antenna 40. Conversely, the antenna current on parasitic patch 112 and conductive interconnect structure 118 may be produced by radio-frequency signals incident upon antenna 40. The antenna current on parasitic patch 112 may induce corresponding antenna current on directly fed patch 90 via near-field electromagnetic coupling 110. When configured in this way, parasitic patch 112 and conductive interconnect structure 118 may collectively form an indirectly fed antenna resonating element or parasitic (e.g., a parasitic antenna resonating element) for antenna 40. Parasitic patch 92, parasitic patch 112, conductive interconnect structure 118, and directly fed patch 90 may collectively form the antenna resonating element for antenna 40.

The example of FIG. 8 is illustrative and non-limiting. If desired, antenna 40 may include one or more additional grounded parasitic patches in one or more additional planes (e.g., non-coplanar with directly fed patch 90, parasitic patch 92, and/or parasitic patch 112) and/or may include one or more additional grounded parasitic patches coplanar with parasitic patch 112 or coplanar with parasitic patch 92. Parasitic patch 92 may have any desired shape (e.g., having any desired number of straight and/or curved edges, any desired number of segments, branches, or arms extending in different directions, etc.). Directly fed patch 90 may have any desired shape (e.g., having any desired number of straight and/or curved edges, any desired number of segments, branches, or arms extending in different directions, etc.).

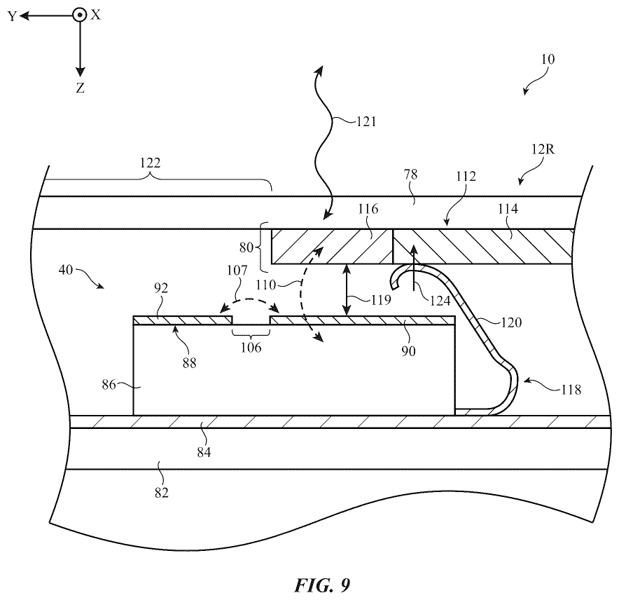

To integrate antenna 40 of FIG. 8 into device 10 for conveying radio-frequency signals through rear housing wall 12R (FIGS. 1 and 6) without increasing the size of device 10, parasitic patch 112 may be formed from a conductive portion of the housing 12 of device 10. FIG. 9 is a cross-sectional side view showing one example of how antenna 40 of FIG. 8 may be integrated into device 10.

As shown in FIG. 9, flexible printed circuit 82 may be mounted in the interior of device 10 with substrate 86 facing rear housing wall 12R. Lateral surface 88 of substrate 86 may be separated from conductive support plate 80 in rear housing wall 12R by gap 119. Parasitic patch 92 and directly fed patch 90 may extend or lie within a first plane. Rear housing wall 12R may include an opening in conductive support plate 80 such as aperture 122. Conductive support plate 80 may extend or lie within a second plane parallel to the first plane (e.g., separated from the first plane by gap 119). The first and second planes may extend parallel to the lateral area of dielectric cover layer 78, the rear face of device 10, and the front face of device 10 if desired (e.g., the X-Y plane). Dielectric cover layer 78 of rear housing wall 12R may overlap both conductive support plate 80 and aperture 122. Aperture 122 may, if desired, form a slot between conductive support plate 80 and peripheral conductive housing structures 12W (FIG. 6). Aperture 122 may overlap some or all of parasitic element 92, some or all of gap 106, and/or some of directly fed patch 90. Aperture 122 may be non-overlapping with respect to directly fed patch 90 if desired.

The parasitic patch 112 of antenna 40 may be formed from a conductive portion of rear housing wall 12R such as an integral portion of conductive support plate 80 (e.g., an integral portion of conductive support plate 80 at, defining, and/or protruding into aperture 122). Segment 116 and/or segment 114 may be formed from different segments of conductive support plate 80 (e.g., overlapping directly fed patch 90). Conductive interconnect structure 118 may electrically couple (short) conductive support plate 80 (e.g., at segment 114 of parasitic patch 112) to ground traces 84 (e.g., extending from the second plane containing parasitic patch 112 to a third plane that contains ground traces 84). If desired, spring finger 120 of conductive interconnect structure 118 may exert a spring force 124 against segment 114 of parasitic patch 112 to help maintain a robust electrical connection between parasitic patch 112 and ground traces 84.

While conveying radio-frequency signals, directly fed patch 90 may indirectly feed parasitic patch 92 via near-field electromagnetic coupling 107 across gap 106 (e.g., within the first plane). At the same time, directly fed patch 90 may indirectly feed parasitic patch 112 and conductive interconnect structure 118 via near-field electromagnetic coupling 110 across gap 119 (e.g., between the first and second planes). Antenna current on parasitic patch 92 and directly fed patch 90 may radiate radio-frequency signals 121 through aperture 122, dielectric cover layer 78, and rear housing wall 12R. At the same time, antenna current on parasitic patch 112 and conductive interconnect structure 118 may radiate radio-frequency signals 121 through dielectric cover layer 78 and rear housing wall 12R (e.g., outside of aperture 122). Conversely, radio-frequency signals 121 incident upon rear housing wall 12R may produce antenna current on parasitic patch 112 and conductive interconnect structure 118 through dielectric cover layer 118, may produce antenna current on parasitic patch 92 and directly fed patch 90 through aperture 122 and dielectric cover layer 78, and/or may produce antenna current on directly fed patch 90 via near-field electromagnetic coupling 107 from parasitic patch 92 and/or via near-field electromagnetic coupling 110 from parasitic patch 112.

Parasitic patch 112, conductive interconnect structure 118, and parasitic patch 92 may serve to broaden the bandwidth of antenna 40. At the same time, parasitic patch 112 and conductive interconnect structure 112 may serve to increase the resonating volume/size of antenna 40 to include the entire volume of device 10 extending from ground traces 84 to dielectric cover layer 78, helping to increase the efficiency of antenna 40. Further, integrating parasitic patch 112 into conductive support plate 80 may prevent the need for adding additional parasitic elements into device 10 (e.g., increasing the amount of space in device 10 for other components) while also allowing parasitic patch 112 to contribute to the mechanical strength and integrity of the housing for device 10.

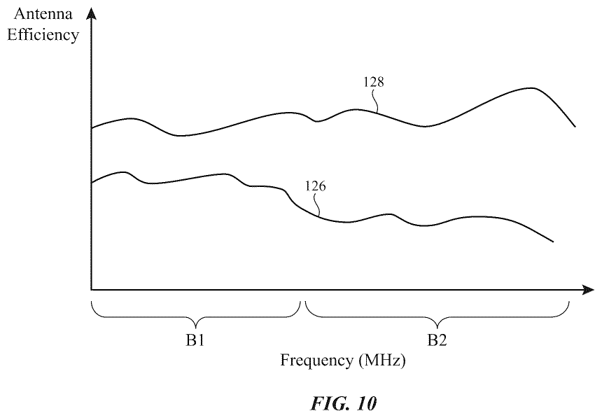

FIG. 10 is a plot of antenna performance (antenna efficiency) as a function of frequency for antenna 40. Curve 126 plots the response of antenna 40 in the absence of parasitic patch 112 and conductive interconnect structure 118 (e.g., as shown in FIG. 7). Curve 128 plots the response of antenna 40 having parasitic patch 112 and conductive interconnect structure 118 (e.g., as shown in FIG. 8).

As shown by curves 128 and 126, parasitic patch 112 and conductive interconnect structure 118 may serve to increase the antenna efficiency of antenna 40 across at least a first band B1 and a second band B2 for the radio-frequency signals 121 (FIG. 9) conveyed by antenna 40 through rear housing wall 12W. Band B1 may extend from around 5000 MHz to around 5825 MHz and band B2 may extend from around 5825 MHz to around 7715 MHz, as one example. The radio-frequency signals 121 (FIG. 9) conveyed by antenna 40 of FIGS. 8 and 9 may, for example, include WLAN signals conveyed in a 5 GHz WLAN band and UWB signals conveyed in a UWB band. The example of FIG. 10 is illustrative and non-limiting. Curves 126 and 128 may have other shapes in practice. Bands B1 and B2 may cover any desired frequencies.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made by those skilled in the art without departing from the scope and spirit of the described embodiments. The foregoing embodiments may be implemented individually or in any combination.

What is claimed is:

1. An electronic device comprising:
peripheral conductive housing structures;
a display mounted to the peripheral conductive housing structures;
a dielectric cover layer mounted to the peripheral conductive housing structures opposite the display;
a conductive plate extending along the dielectric cover layer;
ground traces;
a conductive interconnect that couples the ground traces to a portion of the conductive plate; and
an antenna configured to convey radio-frequency signals through the dielectric cover layer, wherein the antenna includes
a directly fed patch overlapping the portion of the conductive plate,
a first parasitic element coplanar with the directly fed patch, and
a second parasitic element that includes the portion of the conductive plate and the conductive interconnect.

2. The electronic device of claim 1, further comprising:
a substrate, wherein the directly fed patch and the first parasitic element are disposed on a lateral surface of the substrate.

3. The electronic device of claim 2, wherein the directly fed patch has a first edge and a second edge opposite the first edge, the first parasitic element has a third edge and a fourth edge opposite the third edge, the third edge is separated from the first edge by a first gap at the lateral surface of the substrate, and the directly fed patch is separated from the portion of the conductive plate by a second gap.

4. The electronic device of claim 3, wherein the directly fed patch is configured to indirectly feed the first parasitic element via a first near-field electromagnetic coupling across the first gap and is configured to indirectly feed the second parasitic element via a second near-field electromagnetic coupling across the second gap.

5. The electronic device of claim 4, further comprising:
a first fence of conductive vias that couple the fourth edge of the first parasitic element to the ground traces through the substrate; and
a second fence of conductive vias that couple the second edge of the directly fed patch to the ground traces through the substrate.

6. The electronic device of claim 5, wherein the conductive interconnect comprises a conductive spring finger.

7. The electronic device of claim 6, wherein the portion of the conductive plate includes first and second segments, the first segment extends along a first longitudinal axis and overlaps the directly fed patch, the second segment extends from an end of the first segment along a second longitudinal axis orthogonal to the first longitudinal axis, and the conductive spring finger is pressed against the second segment.

8. The electronic device of claim 5, wherein the first parasitic element has a fifth edge extending from the third edge to the fourth edge, the first parasitic element has a sixth edge extending from the third edge to the fourth edge opposite the fifth edge, and the electronic device further comprises:
a third fence of conductive vias that couple the fifth edge of the first parasitic element to the ground traces through the substrate; and
a fourth fence of conductive vias that couple the sixth edge of the first parasitic element to the ground traces through the substrate.

9. The electronic device of claim 2, further comprising:
a flexible printed circuit, wherein the ground traces are disposed on the flexible printed circuit, the substrate being surface mounted to the flexible printed circuit.

10. The electronic device of claim 1, wherein the portion of the conductive plate includes first and second segments, the first segment extends along a first longitudinal axis and overlaps the directly fed patch, the second segment extends from an end of the first segment along a second longitudinal axis orthogonal to the first longitudinal axis, and the conductive interconnect is coupled to the second segment.

11. The electronic device of claim 1, wherein the portion of the conductive support plate is laterally separated from the peripheral conductive housing structures by an aperture that overlaps the first parasitic element.

12. An electronic device comprising:
a dielectric cover;
ground traces;
first and second conductive patches interposed between the dielectric cover and the ground traces, the second conductive patch being separated from the first conductive patch by a first gap;
a third conductive patch interposed between the second conductive patch and the dielectric cover and separated from the second conductive patch by a second gap; and
a positive antenna feed terminal coupled to the second conductive patch, wherein
the first, second, and third conductive patches are configured to radiate radio-frequency signals through the dielectric cover,
the second conductive patch is configured to indirectly feed the first conductive patch across the first gap, and
the second conductive patch is configured to indirectly feed the second conductive patch across the second gap.

13. The electronic device of claim 12, wherein the first conductive patch is coplanar with the second conductive patch.

14. The electronic device of claim 12, wherein the third conductive patch includes a first segment extending along a first longitudinal axis, the third conductive patch includes a second segment extending from an end of the first segment along a second longitudinal axis orthogonal to the first longitudinal axis, and the first segment overlaps the second conductive patch.

15. The electronic device of claim 14, further comprising a conductive interconnect that couples the second segment to the ground traces.

16. The electronic device of claim 12, further comprising:
a conductive interconnect that shorts the third conductive patch to the ground traces.

17. The electronic device of claim 16, further comprising:
a substrate, the first and second conductive patches being disposed on the substrate; and
a fence of conductive vias that couple the second conductive patch to the ground traces through the substrate.

18. The electronic device of claim 12, further comprising:
a housing that includes a conductive support plate extending along the dielectric cover, wherein the third conductive patch comprises an integral portion of the conductive support plate.

19. An antenna comprising:
a ground;
a first patch overlapping the ground;
a second patch overlapping the ground and separated from the first patch by a first gap, wherein the first and second patches are in a first plane;
a third patch that overlaps the first patch and that is in a second plane separated from the first plane by a second gap;
a conductive interconnect that couples the third patch to the ground; and
a positive antenna feed terminal coupled to the first patch, wherein the first patch is configured to
indirectly feed the second patch via a first near-field electromagnetic coupling across the first gap, and
indirectly feed the third patch and the conductive interconnect via a second near-field electromagnetic coupling across the second gap.

20. The antenna of claim 19, further comprising:
a substrate, the first and second patches being patterned onto a surface of the substrate, wherein the first patch has a first edge and a second edge opposite the first edge, the second patch has a third edge and a fourth edge opposite the third edge, and the first edge is separated from the third edge by the first gap;
a first fence of conductive vias that couple the second edge of the first patch to the ground through the substrate; and
a second fence of conductive vias that couple the fourth edge of the second patch to the ground through the substrate, wherein
the third patch has a first segment and a second segment, the first segment extends along a first longitudinal axis and overlaps the first patch, the second segment extends from an end of the first segment along a second longitudinal axis orthogonal to the first longitudinal axis, and the conductive interconnect couples the second segment to the ground.
